(19) United States
(12) Patent Application Publication
(10) Pub. No.: US 2016/0055593 A1
(43) Pub. Date: Feb. 25, 2016

(54) System and Method to Predict Field Access and the Potential for Prevented Planting Claims for Use by Crop Insurers

(71) Applicant: David P. Groeneveld, Santa Fe, NM (US)

(72) Inventor: David P. Groeneveld, Santa Fe, NM (US)

(21) Appl. No.: 14/831,330

(22) Filed: Aug. 20, 2015

Related U.S. Application Data
(60) Provisional application No. 62/040,146, filed on Aug. 21, 2014.

(51) Int. Cl. G06Q 40/08; G06Q 50/02; G06F 17/30

(52) U.S. Cl. CPC G06Q 40/08; G06F 17/30557; G06Q 50/02

(57) ABSTRACT

A field visit or other verification is required to verify each prevented planting PP (PP) claim after it is filed. No measurements pursuant to calculating crop loss are taken during this initial visit, only general information and photographs are collected to demonstrate claim validity. PP claims occur most often in very wet years with high claim density (claims/policies) that strains crop loss adjusting staff and causes significant costs to support what generally is no more than a picture of a soggy field and notes to that effect. Through the use of statistically and physically-based models the present invention provides estimates of the probability for PP claims throughout huge geographic regions potentially obviating nearly all field confirmation except for claims filed for conditions of low forecasted claim probability that have higher potential for insurance fraud.

### RELATED APPLICATIONS

This application claims the benefit of U.S. Patent Application No. 62/040,146, filed Aug. 21, 2014. This provisional patent application listed above is incorporated herein by reference in its entirety.

### BACKGROUND OF THE INVENTION

1. Field of the Invention

The present invention relates generally to the field of analysis for crop loss adjusting for the crop insurance industry.

2. Background

Wet field conditions that prevent a farmer from planting are often indemnified by crop insurance. When wet conditions occur, farmers may not be able to enter their fields to plant crops. Planting is a time-critical operation with potential economic consequence because planting must occur within a specified window of the finite growing season that is curtailed by frost each fall. Crop insurance is written specifically to cover the losses when such prevented planting (PP) conditions occur.

Crop insurance loss adjusters who work for the approved insurance providers (AIPs) frequently need to access cropped fields, for example to check each field to determine whether wet conditions leading to prevented planting have actually occurred. After receiving notice of a claim, crop insurance companies send personnel to visit the field to confirm that wet conditions have occurred conducive to prevented planting. Additionally, for all crop loss adjusting, not just PP, visits to assess the degree of loss must coincide with conditions that allow for the adjuster to access all portions of the fields, a requirement that may be prevented by boggy fields from recent rain that exclude access by vehicle or foot. In the absence of a tool to predict when such conditions occur, crop loss adjusters are frequently dispatched to work claims across fields that they can't access, thus causing great and futile expense to the insurance provider.

Generally, two visits are required by the Risk Management Agency (RMA) that manages the federal crop insurance program for documenting PP. The first visit is to confirm that the field is wet to document the validity of the claim. The point of the present invention is to use numerical means to document that conditions are sufficiently wet somewhere in the field that prevent access, thus making the first visit unnecessary. This invention will transform standard operating procedures to save the expense and labor associated with making many thousands of unnecessary field visits each year.

What is needed is a means for determining PP claim validity that does not require mobilization for field visits and that is based upon data that can be readily acquired and modeled. Rather than a field visit, field conditions governing both prevented planting and field access can be predicted accurately given readily available data. For example the amount of precipitation that has been received prior to and during the period necessary for field access, either for planting or performing crop loss adjusting can be accurately determined. Other spatial attributes of farmed land such as slope and soil types also exert a direct controlling effect for how wet a field is, given antecedent precipitation. An additional benefit from such an invention is the ability to clearly document where insurance fraud is likely, since during regional prevented planting conditions, crop loss adjusters are often too busy to visit all claims. Focusing adjuster resources where PP conditions are unlikely can reduce the potential for fraud, thereby solving a serious concern for the crop insurance industry and the federal government that backs it.

### BRIEF SUMMARY OF THE INVENTION

The system and method use physical factors and models to determine whether to send or not send a crop loss adjuster to confirm the presence of surface wetness on a cropped field that is the subject of a PP crop insurance claim from wet field conditions. The models are of two types, a database model (DBM) and a remote sensing model (RSM); both are spatial and use data rasters as input and output.

The DBM uses antecedent rainfall, variable in time and space, and slope and soil data that are variable only in space but otherwise invariant. Calibration of the database model is accomplished using multiple linear regression of the historic ratio of claims to policies, called claim density, as the dependent variable predicted by antecedent rainfall, slope and soil properties. Calibration produces factors that can then be applied with raster inputs of slope and soil properties and the antecedent precipitation for each year. The claim density that is predicted is a statistic that can be evaluated with a threshold to determine whether a claim should be visited, or not. The threshold is based on the fact that PP claims for fields that have low predicted claim density have high potential for insurance fraud.

The remote sensing model uses rasters of water-band shortwave infrared band (SWIR) measured by Earth observation satellite (EOS) obtained during the planting period. Calibration is accomplished by determining the average planting season SWIR response for every pixel across a region of interest. For the planting period year of interest with PP likelihood and evaluation of each PP claim, a normalized wetness index (NWI) is calculated for the per-pixel SWIR response versus a long-term average calculated for that pixel. This comparison results in maps and statistics for all fields with claimed PP losses. Application of the RSM provides an independent check of the DBM for any year of interest and for all pixels within fields with claims.

### BRIEF DESCRIPTION OF DRAWINGS

FIG. 1—a table format for arraying modeled factors into the DBM.

FIG. 2—example output from DBM for hypothetical Field m.

FIG. 3—flowchart of calibration activities for the DBM and RSM.

FIG. 4—flowchart operational application of DBM and RSM.

### LIST OF ABBREVIATIONS USED AND THEIR DEFINITIONS

AIP—Approved insurance provider.

CLU—common land unit, a unique numeric designator for all cropped fields in the US.

DBM—database model, developed as part of the present invention.

DEM—digital elevation model.

EOS—Earth observation satellite.

Field m—a hypothetical field that may need confirmation of wetness after a claim is filed for prevented planting losses.

Multi-peril crop insurance—crop insurance that covers a crop loss occurring from any cause.

Multiple linear regression—a method to model the relationship between two or more explanatory variables and a response variable by fitting a linear equation to the observed data. All values of an independent variable x is associated with a value of the dependent variable y.

NPCI—named peril crop insurance that indemnifies the losses from a named peril, for example losses from prevented planting.

NED—National Elevation Dataset.

PP—prevented planting.

PLSS—United States Public Land Survey System.

R²—coefficient of multiple determination that results from a multiple regression model fitting that defines the amount of variance that is explained by the model.

RMA—An agency of the United States Department of Agriculture Risk Management Agency that regulates the crop insurance industry and an agency of the United States Department of Agriculture.

RSM—remote sensing model, developed as part of the present invention.

SSURGO—USDA Soil Survey Geographic Database, a digital resource of mapped soil data pertinent assessing PP conditions.

SWIR—shortwave infrared light—used here for wavelengths from about 1.5 μm and 1.7 μm, a water absorption portion of larger SWIR spectrum.

USGS—United States Geological Survey, a division of the Department of the Interior.

NWI—normalized wetness index, calculated from water absorption SWIR and used to determine the departure of any year of interest from the long term average.

### DETAILED DESCRIPTION OF ONE EMBODIMENT OF THE PRESENT INVENTION

Rich databases exist for precipitation and PP insurance claims. The embodiment of present system and method invention disclosed here combines these databases to determine under what antecedent precipitation conditions PP conditions will occur. Such forecasting ability also provides a competent surrogate to assess field access for crop loss adjusting during any time of the year. Another application for the system and method of the embodiment of the present invention is for crop insurers to mobilize funds in anticipation of losses resulting from prevented planting claims that can be extensive in magnitude and area.

This system and method is developed by first combining data for prevented planting loss claims and those parameters related to field access, such as precipitation, soil properties and topographic slope. These data are combined digitally and spatially in rasters for each pixel for a unit geographic region, for example by county or by distinct topographic region. The combined data are then tested statistically to develop a predictive model representing the statistics of prevented planting conditions particular to the unit region. The output from each regional statistical model can then be used to predict the expected incidence of prevented planting claims and to predict where these claims will occur spatially. This method and system is called is abbreviated DBM.

The DBM is applied to each prevented planting claim as it is reported. As for all crop insurance loss claims, PP is reported with information that specifies its location. The inputs for each unit regional model are spatially defined for all locations with the DBM with the mathematical operations occurring through raster manipulation, pixel by pixel. In operation, data are extracted from the raster of DBM results to determine the probability for a PP claim for each pixel of each field upon which a PP claim has been filed. A spatial probability map of each subject field is then provided as documentation for the files for each claim in addition to results from the RSM. These results can replace expensive field visits to document the claim's validity for the field being wet or conversely, ensure that the subject field is visited in the attempt to prevent insurance fraud.

Corroboration of the DBM is valuable as a test for the preponderance of spatially-defined surface wetness conducive to PP claims. Data collected using Earth observation satellites (EOS), specifically in the short-wave infrared (SWIR) region of the spectrum, wavelengths from 1.5 μm to 1.7 μm, can be used to portray the wetness of the land surface. Exposed water molecules absorb virtually all of the energy they receive from the sun in the SWIR region. SWIR EOS data can be calibrated statistically to spatially-display wetter-than-normal conditions for corroborating the DBM. Hence, through this system and method, two very different models are brought to bear to define the statistical likelihood of wet conditions on any farmed field. This second model is called the remote sensing model and abbreviate as RSM.

### Database Model Inputs

Input data for the DBM consists of spatially-defined images called rasters. Rasters are image files that contain x and y coordinates that define the location on the Earth's surface, while the z value at each x and y location has some magnitude. For example, a raster image of the earth could be a gray scale representation like a black and white photograph. In that case, the magnitude would portray peak brightness as white and minimal brightness as black. Rasters contain values for each pixel. Rasters can store other information, for example rainfall, that can be interpolated across the x and y dimensions of the Earth's surface from the point measurements made at weather stations.

Rasters enable the technology used in the present invention because multiple rasters can store many different kinds of spatial data that are required by the DBM, examples being antecedent precipitation, soils properties, and topographic slope. Raster's are essentially image files that can also be used to express how some parameter may vary across the landscape. Each xy datum in this context is a pixel. Pixels can be manipulated using mathematical operations for example addition, subtraction, and multiplication, as well as higher-level mathematical operations in the form of statistics that can be generated, manipulated and stored in rasters. For the DBM, this mathematical manipulation includes digesting millions of pixels for generation of multivariate statistical models for assessing the PP potential of any field given multiple rasters of physical variables that affect surface wetness across the region.

The DBM is developed using multivariate statistics through spatially discrete variables. For multivariate statistical analysis, it is important to use data that are consistent from year to year. Calibration of the DBM requires statistics of policies and claims, non-varying parameters such as topographic slope and soil properties, and temporally- and spatially-varying inputs such as antecedent precipitation.

PP statistics require normalization of claims through calculation of claim density—the total number of claims divided by the total number of policies. A person having ordinary skill in the art will appreciate that claim density can be characterized within a given unit region either as total number of claims divided by total number of policies, or as a total area of claims divided by total area covered by policies. Both PP claim tracking and the requirement for the AIP to send adjusters to verify the validity of the claim are essentially yes/no propositions, regardless of the area affected in the indemnified field. It is therefore more direct and robust to calibrate and operate the model on a numerical rather than areal basis. A person of ordinary skill will appreciate, however, that the DBM can be calibrated to either, or both, data representations.

There are two basic types of policies that cover PP. These are multi-peril crop insurance, abbreviated MPCI, and what will be termed here “named peril crop insurance” (NPCI). NPCI is additional insurance that indemnifies only for crop losses from the named peril, for example PP. NPCI operates in addition to the indemnification for such losses within MPCI.

Only the MPCI should be used for calibration of the DBM because farmers buy this coverage at the same rate, year after year. Within two states that have the highest rates of prevented planting in the United States, North and South Dakota, the PP NPCI coverage doubles in years with high antecedent precipitation while indemnities increase by about five times over the indemnities that occur during average antecedent precipitation. Thus, NPCI provides inconsistent statistics for description of claim density and should not be used for DBM calibration. The multi-peril coverage provides the ideal statistics for calibration of the database model because policy purchases remain relatively constant from year to year, while PP claims rise and fall dependent upon antecedent precipitation.

Antecedent precipitation is a critical input for DBM calibration and assessment of PP probability. Precipitation is measured at discrete weather stations and these data points can be extrapolated to all points in-between using geostatistics, for example Kriging. Thus, antecedent precipitation for any period of interest measured across the landscape at weather stations can be interpolated to become a raster with values at each pixel for application in calibrating the DBM and once calibrated, for evaluating the probability of each claim.

Calibration of the DBM requires multivariate statistics in the form of multiple linear regression. For multiple regression modeling, some variables can be interpreted statistically in different manners and input to the model multiple times. For example for the prairie pothole region that includes North and South Dakota, antecedent precipitation may best be divided into short-term and long-term. For example, long-term antecedent precipitation can express summation from the previous July through April preceding planting. Within the Dakotas, the highest precipitation statistically occurs during mid summer so summing precipitation from July through April captures both the influence of the highest precipitation during the latter half of the previous summer and also the contribution received through the winter. Late summer precipitation antecedent to the spring planting period can create PP conditions through interaction with the water table that then affects field wetness through capillary rise. Short-term precipitation can be that received during the planting period, April and May. Both short-term and long-term precipitation either alone, or in combination, result in fields that are too wet for entry, hence, both variables are best included separately in the database model to forecast PP conditions in North and South Dakota.

Data for soil properties are another set of spatially-defined inputs that can be stored and manipulated in rasters. For a given location, soil properties are invariant as opposed to antecedent precipitation that is highly variable both temporally and spatially. Mapped soil properties such as depth to the water table and drainage classes that are descriptive for the effect of water retention in the soil are two such properties of value for application.

The USDA has mapped agricultural fields through the Soil Survey Geographic Database (SSURGO) program. Variables that are pertinent within SSURGO include depth to the water table in the spring and annually, soil water holding capacity, and soil drainage. These are variables of interest for the present system and method since these variables provide measures related to how rapidly surface water affecting field access will leave or remain in place for a given level of antecedent precipitation.

Topographic slope is another temporally invariant but spatially-variable input to the DBM. The topographic land surface is represented within a digital elevation models (DEMs) that are rasters available from the USGS and other public domain sources. The DEM land surface data can be manipulated to provide slope in raster format for pixels across the landscape that are on the order of a few to tens of meters in scale. The superior choice for the analysis described here is the DEM available from the USGS National Elevation Dataset (NED) that has 30-m pixels that are sufficiently fine resolution for use on virtually all farmed lands while controlling the file size when utilized across the large areas involved in the multivariate modeling.

Within any field, the potential for PP conditions is directly tied to the physical characteristics that govern the timing for water storage and drainage. Well-drained soil on steep slopes drains quickly after precipitation events and is not readily affected by a shallow water table. Fields with flat slopes and poor drainage are more likely to have shallow water tables and are much more likely to suffer from some degree of PP each year. Slope is a critical variable because PP conditions are due to lack of drainage from the land surface. Fields with relatively steep slopes shed water and therefore have very low incidences of PP claims while those that are flat must drain internally, a process that may take months and render the ground incapable of supporting farmer access for planting. Although slope is contained in the SSURGO data and can be used in calibration, more direct and easily manipulated data are available from analysis of the NED DEM that has 30 m pixels.

### Calibration of the Database Model

Sources of calibration data are potentially the database archives kept by individual crop insurance companies. The ideal input for calibration of the DBM is MPCI policies and claims tracked with spatial identification, especially by shapefiles. Currently, MPCI archives of most crop insurers have location designations to the nearest section (square mile) within the United States Public Land Survey System (PLSS) through range, township and section designations. In 2016, as required by the government agency that administers the crop insurance program, the United States Department of Agriculture (USDA) Risk Management Agency (RMA), the crop insurance industry will make the switch to geolocation data for each field and this will occur in the form of shapefiles. Shapefiles are a widely used geospatial vector data format for geographic information system (GIS) software. The present invention can use either PLSS or shapefiles for calibration. At present, most databases code to the PLSS designations and this is the likely format for spatial data to locate individual fields and their policies and claims. However, the crop insurance industry is converting to shapefile format that will make calibration more accurate and robust. In reference to calibration for this system and method, both geospatial formats are incorporated herein.

Calibration of the DBM consists of multivariate modeling techniques. Multiple linear regression has been used on crop insurance PP data and found to yield acceptable results. Although other multivariate methods can be used in model calibration and operation for the system and method, multiple linear regression is a simple and powerful tool having the basic format of Equation 1.

yᵢ=β₀+β₁xᵢ₁+ . . . β₂xᵢ₂+ . . . βₚxᵢₚ+εᵢ for i=1,2, . . . n. Equation 1
Where yᵢ is claim density, an annual measure of prevented planting claims divided by policies expressed in terms of either counts or area; β values are constants through multiple linear regression for variables designated as x values; i refers to variables input to the multiple linear regression analysis, perhaps defined spatially as per unit region, and εᵢ is the residual error associated with each variable.

Expressed in words, Equation 1 is DATA=FIT+RESIDUAL where all x variables have a fitted constant value, β, and a residual error E according to the data values, y. The multiple linear regression models are fitted using software because of the complexity for the calculations. Acceptable results for the DBM model have been obtained using three or more variables: precipitation divided into two antecedent periods and average slope are the most influential variables. Less influential but still potentially important for the present invention are expressions of soil information that directly affect surface wetting published within the USDA SSURGO dataset. For any individual region for DBM fitting and application, the various soil properties may have more or less affect and so, should always be included in at least the model calibration phase.

All of the DBM inputs are spatially variable but can be divisible into temporally static data, for example classes of topographic slope that can be derived from published DEM datasets. Other static parameters that vary spatially are USDA-mapped soil texture, infiltration capacity, drainage class and depth to groundwater that further control the rate that surface water will leave a field once received from precipitation or through capillary rise from the water table. Rates of evaporation are an additional model component that can then predict as probability when hypothetical field conditions can again become dry enough to permit entry under conditions of no further rain. Evaporation rates are an additional component that can be used to forecast when fields can be entered by crop loss adjusters later in the year for purposes of assessing crop loss from any cause.

The multiple linear regression method outlined in Equation 1 uses parametric statistics for calibration and prediction, while the result for any particular field for whether there is a claim, or not, is non-parametric. This offers a challenge for both calibration and application because the two types of data are not compatible unless the non-parametric data are transposed into parametric statistics, for example into a probability. For the present invention, this is accomplished by stratifying the unit geographic region by the invariant parameter of slope and using each of the stratified portions to be the basis for modeling, thus providing multiple models to characterize claim density over the unit geographic region. The calculation of claim density across the entire stratified slope class, dividing the total claims by the total policies within the class, changes the claims from non-parametric to parametric, thus enabling the use of multiple linear regression. Establishing a grid across the unit geographic region, for example with square cells ten miles on a side, provides multiple samples for comparison of gridwise claim density to and all of independent variables in the model.

For a unit geographic region for the prairie pothole region, a 10×10 mile grid-wise division will result in the potential for thousands of individual grid cells for calibration. The gridcell division results in classes that are disjointed and peppered-about throughout the larger unit geographic region. The consequent spatially diverse sample enables robust calibration using relatively few years, since across large unit geographic regions, lands within the same slope class will tend to experience many different combinations of antecedent precipitation from dry to wet as well as a range of mapped soil properties.

During both calibration and application, water bodies must be removed from consideration using the water-absorption SWIR band of EOS data, for example as available through Landsat TM. The 30-m pixels of Landsat TM are an excellent choice since they are equivalent in scale to the preferred NED DEM. Water bodies are removed because they have zero slope and are not farmed. For the unit geographic region containing prairie potholes, this is an extremely important step.

As will be appreciated by a person with ordinary skill, calibration of each regional DBM requires the use of multiple model runs. These individual iterations are used to choose the most robust and accurate model calibration from various formulations of antecedent precipitation, various grid cell sizes, various slope classes and which of the soil properties are the most effective, if any. DBM performance for each of the iterations is evaluated using the R² value that results from the model, also called the coefficient of multiple determination. Values of R² infer how much of the variance is explained by the model, with unity being a perfect fit and zero explaining none of the variance. For any DBM region, these iterations and the chosen model also determine the formulation of the independent variables.

### Operation of the Database Model

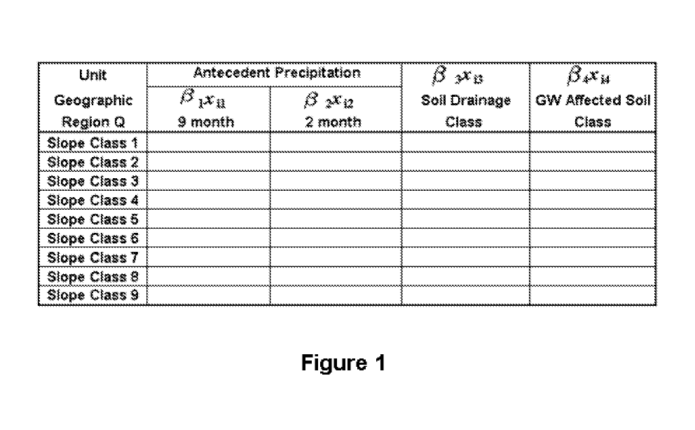

Once calibrated, the DBM can be encoded as β values for each independent variable as a lookup table in the format illustrated in FIG. 1. In operation, the DBM can be run most efficiently as rasters for the entire unit geographic region to generate pixel values of probability, as expressed by predicted claim density. Many claims can be rapidly and efficiently assessed across the entire unit geographic region using such raster-based calculations when followed by extraction and parsing of the results to the correct account for each claim using the shapefile to discriminate the pixels within each field of interest. A generic Field m is used here as a convenient means to express a field with a PP claim. Running the DBM, operationally, uses raster mathematics in the format of Equation 1 pulling the appropriate β values from the lookup table (FIG. 1) with the xᵢ values for each pixel providing the data input. These calculations are all accomplished using raster mathematics across the entire unit geographic region without regard to the individual claims during these calculations.

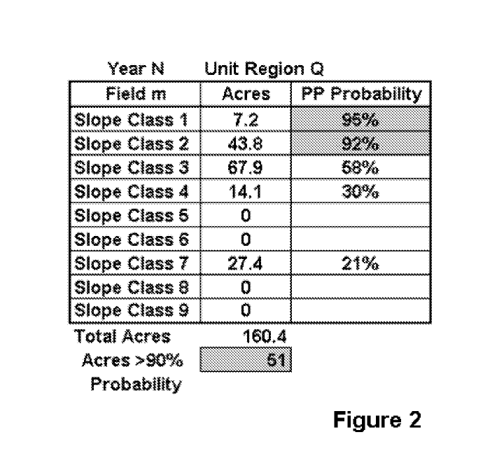

The results from the DBM extracted for all pixels within the Field m shapefile borders, provide a breakdown of the acres and associated predicted PP probabilities for Field m. The area of pixels is readily converted to acres for each slope class. FIG. 2 provides an example of the type of output for a 160.4 acre field. Probabilities that were predicted to be greater than 90% have been highlighted, totaling 51.1 acres. Note that the mathematics for slope and PP probability are highly covariant since the flatter the slope, the greater the potential for PP conditions to occur. These same pixels can be used as a map to show those areas with the greatest probability for prevented planting conditions. Such maps are potentially highly valuable for the AIP and can be sent along with the statistical data arising from application of the DBM.

Once the probability for PP is calculated for Field m, the present system and method then parses the DBM probabilities to the AIP addressed to the files for the Field m PP claim, conveniently tracked, for example, by the Field m common land unit (CLU) designator. When a high probability for prevented planting conditions on Field m is estimated, it obviates the need for an initial field visit to document the presence of surface wetness since there is a high probability that the claim is correct and PP conditions exist in the field. Conversely, any Field m that shows very low probability for PP conditions must be visited to assess the conditions to potentially uncover insurance fraud. The present invention does not replace the actual loss adjustment that must take place later in the year when PP-affected areas are starkly different than crop canopies and can be readily mapped using remote sensing techniques.

The probabilities for the total PP-affected acreage for all Fields m across the unit geographic region can be used as a forecasting tool for financial set-aside by each AIP in anticipation for PP crop loss payouts across large geographic regions. In an alternate embodiment, this system and method is calibrated for conditions later in the growing season to determine the probability for field access that can allow adjusters to work any claim, not just PP.

RSM results have the potential for entry into the DBM through a calibration step that incorporates the RSM result that is then extracted per each claim and entered into the model. Because of cloud cover, however, the RSM data may not be available at resolution appropriate for entry into the DBM. For example, Landsat TM data at 30 m pixels has obvious applicability for use in the DBM. MODIS 500 m SWIR pixels (each about 61 acres) are not expected to add materially to the DBM results because they are generally too large for the scale of slope variability.

### Remote Sensing Model

The RSM provides physical evidence of surface wetting using the SWIR water absorption band. EOS platforms that collect SWIR currently include two at medium resolution with pixels of 30 m, Landsat TM7 and TM8, each collected every 16 days, one low resolution (500 m pixel) MODIS Terra that collected every day, and several collected at higher resolution when purposely tasked (for example World View (3.7 to 4.1 m resolution that is pointable). As more EOS platforms become available, SWIR data will also become more available. For convenience, “SWIR” will be used here to mean reflectance data collected within the water absorption region of 1.5-1.7 μm.

Cloud-free imagery from SWIR-bearing EOS is used within the RSM for assessing surface wetting during the time of planting. This planting period can be variable depending upon region and crop. For example planting crops in South and North Dakota begins in mid-April and ends after the third week of May through the first week of June, depending upon the crop. Evaluation of surface wetting during, but more toward the end of this planting period, offers physical evidence to corroborate findings from the DBM and an easily interpretable map of wetted surfaces relative to any field of interest for a PP claim. This visual evidence will be sent to the PP to AIP along with the results from the DBM tracked by CLU or other unique designator.

Calibration of the RSM requires numerous archived images of the region of interest that surrounds the field where the PP claim is made. The appropriate archived images were obtained during the same time period as the PP planting period for the unit geographic region. Such archives exist for Landsat TM and MODIS EOS platforms but are insufficient for commercially-available EOS data. Calibration can use higher resolution data, for example at several meters that is devolved to lower resolution by adjusting the images to the lower resolution platform during the calibration steps followed by resizing the pixels to the higher resolution once the calibration has been completed in a series of steps that a person with ordinary skill will recognize.

Other than conversion to reflectance according to widely recognized procedures, SWIR data requires no other manipulation. The wavelengths of the SWIR data are resistant to the atmospheric scatter and attenuation that plague the use of shorter wavelengths.

The RSM simply calibrates the spectral response in the SWIR band across the chosen geographic region. This calibration is spatial in nature so that the response within each pixel in the image is individually calibrated.

Calibration is performed to determine the normalized wetness index (NWI) as provided in Equation 2. NWI is calibrated pixel by pixel across the image using mathematical relationships that manipulate the input SWIR rasters. Raster mathematics provides a value for each pixel within each unit region evaluated according to:

$${NWI}_{i} = \frac{{SWIR}_{i} - Average {SWIR}_{{i}_{-}}}{Average {SWIR}_{i}} \qquad Equation 2$$

Where “i” is the ith pixel.

NWI is either positive, when the updated image obtained during the planting period has higher SWIR reflectance than the long-term average, or negative if the updated image has lower SWIR response. This response generally ranges between −1 to +0.5. Lower SWIR response occurs when the pixel is wet, either with water held at the soil surface or when ponded in low spots on the field. Negative values of the NWI capture conditions that are wetter than average with the magnitude inferring the degree of departure. The claim density data can be consulted to determine threshold wetness values for high, medium, and low probability for each unit geographic region.

Along with the calibration activities, the archived values for antecedent precipitation and PP policies and claims provide measures to set threshold values for NWI that signify the statistical properties within the unit geographic region. Hence, calibration of the RSM can result in color coded images for NWI that occurred during the planting period. If Field m is cloudfree during the planting period on mid-resolution EOS data, for example 30m Landsat TM data, the RSM can break down the pixels that are wetter than average in much the same way as in the table in FIG. 2 while also providing a map of these locations at the same scale as the mapped classified pixels from the DBM.

### Detailed Work Flow Description

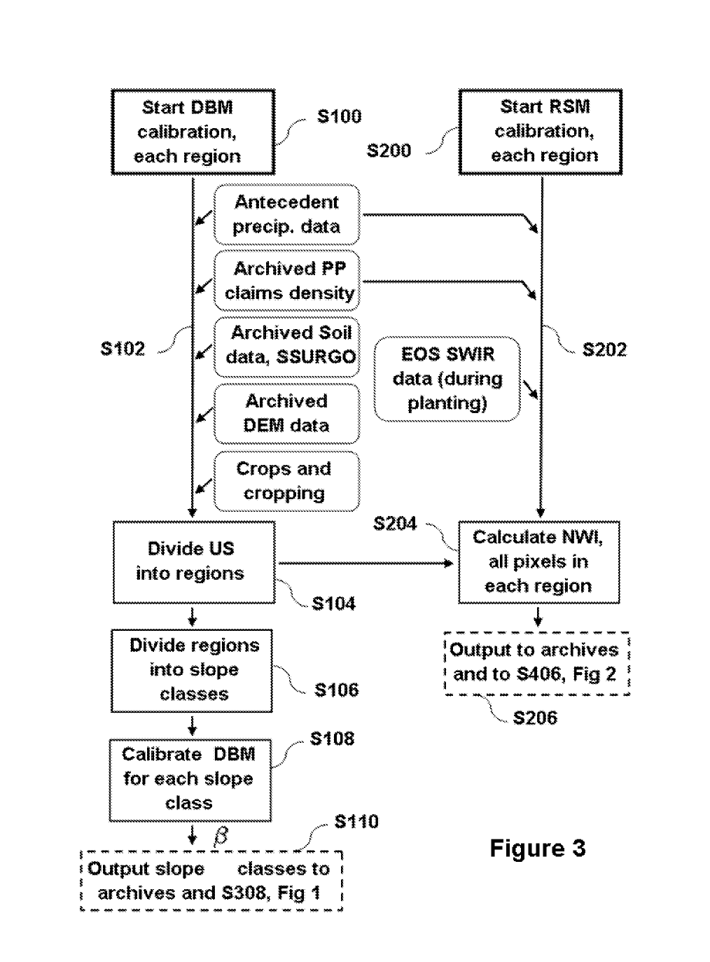

FIG. 3 presents a flowchart that covers model calibration and development for both the DBM and the RSM. The process starts at S100 that requires that DBM calibration is performed for each region. Five separate data archives are tapped to provide spatially discrete input to the model at S102, including variable data of antecedent precipitation and invariant data of historic PP policies and indemnities, pertinent soil data from USDA SSURGO files, DEM data and data on crops and cropping. At S104, these data are parsed into geographic regions that are defined by geomorphology, hydrology, and similar cropping. At S106 the geographic region is divided into slope classes (for example 9 classes as indicated by FIG. 2).

At S108, the DBM is calibrated for each of the slope classes. Not shown are the many terations to insure that the DBM is as accurate and robust as possible.

Independent verification of DBM results is provided by the RSM whose calibration starts at S200. At S202, precipitation and PP policy and claim data are collected for calibration against archived EOS SWIR data obtained during the planting period, for example April and May, with data fed from S204. Calibration of the RSM at S204 results in rasters of average and standard deviation of the SWIR response for each pixel. Through the Landsat program, over 30 years of data are archived and available for calibrating the RSM models. At S204 the data are combined for calibration within each geographic or political unit. AT S206 the RSM calibration is output to archives for future use and is also sent to S406 for application.

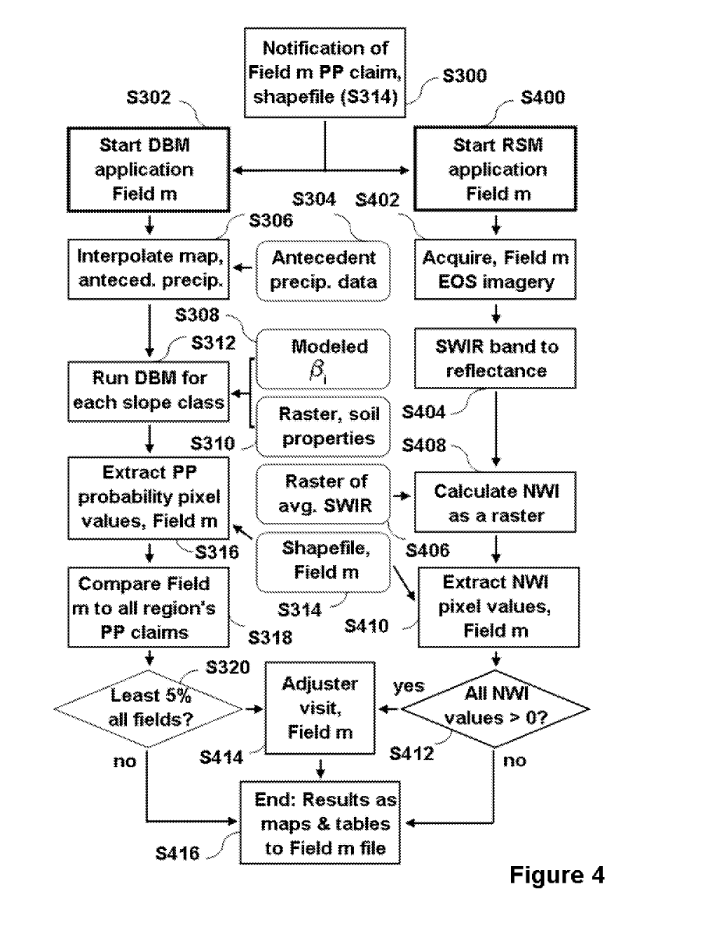

With the steps completed for calibration in FIG. 3, the workflow next moves to the flowchart that governs operational application, FIG. 4. Starting at S300, notification of a PP claim is received for Field m accompanied by a shapefile that passes to S314 for application. At S302, the analysis starts application of the DBM. Data of precipitation are interpolated from point data into continuous rasters across the DBM region at S306 according to the iterative evaluation of the most accurate and robust way to apply these data in the DBM. The antecedent precipitation rasters are downloaded from S304, an archive of precipitation from the preceding July through May in the format specified through iterative fitting of the DBM accomplished at S108.

In combination with βᵢ derived from the calibration per the table in FIG. 1, antecedent precipitation (S306) and soil data (S310) are the xᵢ values used for calculation of PP claim probability represented by the predicted claim density for every pixel in the unit geographic region at S312. This calculation is made per Equation 1 for each of the slope classes chosen for the region-specific DBM during calibration. At S314, a shapefile received with Field m PP claim notification at S300, defines the area for extraction of the probability values for pixels across Field m, extracted at S316 in preparation for comparison to all other PP claims for the year of interest within the DBM at S318.

A query at S320 asks whether Field m is in the least 5% of probability for PP conditions. An answer in the affirmative sends an adjuster to visit and verify PP conditions on Field m as a check against the possibility for insurance fraud. A no answer passes to the end of the process wherein the results from the DBM analysis in the form of maps and tables are send Field m files to provide documentation for PP conditions as required by the USDA RMA.

Returning to S300 that began FIG. 4, the RSM model is applied coincidentally with the DBM starting at S400. Passing to S402, imagery from the planting period for the region of Field m is acquired and then processed to SWIR reflectance at S404. A raster of the average SWIR response is obtained from the archives at S406 for calculation of per pixel NWI that shows the degree of wetness—wetter than average values are less than zero, while dryer than average values are positive, with greater magnitude negative or positive conveying the significance of this diversion.

At S410, the pixels for Field m and surrounding area are extracted using the Field m shapefile from S314 preparatory. At S412 a query is asked whether all the NWI values for Field m are above zero. An answer in the affirmative sends an adjuster to Field m for verification of PP conditions. A visit may already be made in the event of a negative answer to query S320 and in that case, lonely one visit will suffice for both conditions.

A no answer to either queries S320 or S412 sends data to S416 that ends the process by formatting the results from both DBM and RSM analyses of Field m into appropriate maps and tables that are then parsed as documentation to Field m files. These maps and tables are also generated in the case that Field m is visited by an adjuster at S414. A person with ordinary skill in the art will appreciate that if insurance fraud is documented by the adjuster at S414, the maps and tables combined with the results from the field visit may be used for an enforcement proceeding outside of the scope of the present invention. A person with ordinary skill in the art will also appreciate that the criteria of queries S320 and S314 are simply a starting point based upon industry statistics appropriate for sending an adjuster to Field m.

These criteria will need to be reevaluated annually in order to choose the most appropriate metrics upon which to judge when to send an adjuster for verification.

The present invention nearly obviates the need for an initial validation visit for most PP claims. Specious claims will readily stand out because the physical inputs will result in prediction of low probability for a PP claim. Because it promises to reduce costs and enhance efficiency, the crop insurance industry, farmers and agriculture in general will benefit economically from this system and method.

A preferred embodiment of the invention has been described but it will be understood by those of ordinary skill in the art that modifications may be made without departing from the spirit and scope of the invention of the system and method. Accordingly, it is to be understood that the invention is not to be limited by the specific illustrated and described embodiments but only by the scope of the appended claims.

I claim:

1. A system and method for sending crop loss adjusters who document actual PP conditions based on a statistically-created DBM that assesses the probability for a PP claim for an agricultural field m, defined by a shapefile, for use by an AIP who is indemnifying field m comprising:
choosing a region in which to model crop insurance claims arising from PP conditions on any field m;
obtaining historic records of crop insurance policies and PP planting claims with location information;
obtaining records of physical predictive variables that create and govern occurrence of PP conditions, said predictive variables including historic antecedent precipitation data prior to and during historic planting seasons and spatially and temporally invariant properties including slope and soil properties;
calibrating regional DBMs in order to predict the probability for a PP claim using said predictive variables present during historic crop planting periods;
applying the calibrated DBM for said region operationally to generate a statistical probability for a PP claim on field m; and
sending the crop loss adjuster to verify wet conditions conducive to PP conditions based on the regional DBM.

2. The method of claim 1 wherein the step of obtaining data to calibrate the DBM to determine the probability for PP conditions for any field m comprises:
obtaining multiple years of data from the USDA Risk Management Agency and/or AIPs for multi-peril crop insurance and historic data of all policies and all claims within said region;
obtaining weather records from selected stations within and surrounding said region for the said multiple years;
obtaining mapped soil data from public domain sources such as the USDA SSURGO database including drainage class, depth to groundwater, and infiltration capacity; and
obtaining DBM data in the form of rasters and calculating the slope for each pixel in the rasters.

3. The method of claim 1 wherein said step of calibrating each regional DBM includes:
dividing said region into multiple classes defined by slope;
dividing said region into a spatial grid including cells for purposes of sampling for input of paired values for calibration from within each grid cell;
calculating PP claim density for each slope class within each grid cell by dividing the total number of PP claims within each slope class within each grid cell by the total number of multi-peril crop insurance policies within the same slope class within each grid cell; and
and interpolating said precipitation data across said region as rasters.

4. The method of claim 3 wherein said step of calibrating each regional DBM comprises:
extracting and averaging the PP claim density for each slope class in each grid cell;
extracting and averaging the soil properties per each slope class in each grid cell; and
extracting and averaging the antecedent precipitation within each grid cell;

5. The method of claim 3 wherein antecedent precipitation data for the historic PP claims is summed across varying time periods to be used for iterative model fitting to choose the best predictive representation of antecedent precipitation in the DBM for said region.

6. The method of claim 1 wherein said step for calibrating the DBM includes using multiple linear regression for each slope class comprising the steps of:
applying grid cell values of claim density for each slope class as the dependent variable for DBM calibration, each grid cell value paired with the independent variables;
applying antecedent precipitation and soil properties as the independent variables for DBM calibration, each paired with the dependent variable;
performing multiple iterations of inputs to the multiple linear regression analysis to choose the best combination of slope classes to yield regional DBM calibration with the greatest predictive power for each slope class interpreted through the R² resulting from the calibration; and
performing multiple iterations of regional DBM calibration of antecedent precipitation to choose the greatest predictive power for each slope class interpreted through the R² resulting from the calibration.

7. The method of claim 1 wherein application of the regional DBM to predict the probability for PP conditions for field m located within said region comprises the steps of:
obtaining antecedent precipitation for the period of July through May prior to and during the planting period for the region covered by the DBM and converting weather station point data to rasters through interpolation;
assembling model input rasters in the same form as those used in the DBM slope-class models so that all pixels positions are filled with predicted probabilities from the DBM model appropriate for the slope of that individual pixel; and
extracting the pixel values from said probability raster within the boundaries of the shapefile defining field m.

8. The method of claim 7 additionally comprising applying field m pixel probability values including the steps of:
formulating extracted field m pixel PP probability values into a map and a table; and
transmitting the map and table to the indemnifying AIP electronically marked to the field m file using a unique identifier that replaces the need to send an adjuster for the initial confirmation of wet field conditions in 95% of the PP claims;
marking the lowest probability 5% of the PP claims for the collective PP claims within the calibrated region for adjuster visit to evaluate and record field m for wet conditions as a crop fraud preventive measure; and
utilizing the remaining 95% of probability distribution for the collective PP claims as documentation fulfilling RMA requirements.

9. A system and method for creating a statistically-based remote sensing model for determining the departure from average conditions for surface wetness across a region, the surface wetness determining the probable necessity for sending a crop adjuster to enter a cultivated field for purposes of assessing planting conditions, comprising:
assembling a long-term record of SWIR water-band EOS raster image obtained for the region during the planting period within multiple years;
performing statistical analysis for each pixel across the region to determine the long-term average water-band SWIR reflectance during the planting period;
measuring SWIR reflectance from water-band EOS images during the planting season for the year of interest;
calculating the NWI for all pixels across the region of interest for PP claims; by subtracting for each pixel, said long term average planting season SWIR response from said SWIR value measured during the planting season of the year of interest, and dividing this quantity by the long-term average planting season SWIR response;
visiting fields that have PP claims in the region when said NWI values for the year of interest indicate dry conditions have occurred during the planting period;
visiting only those fields with PP claims that have NWI values for all pixels greater than zero, indicating dryer conditions than the long-term average conditions throughout the field; and
utilizing the results for fields with at least some portion having NWI values less than zero as documentation for wet conditions, thereby fulfilling RMA requirements.

11. The method of claim 10 used in an additive manner with the probability results from utilizing the DBM.

12. The system and method for sending insurance claim adjusters to any field m within any calibrated region under consideration for examination of the probability whether a claim for PP that has been filed was too wet for planting or not, performing precedent steps to sending the adjuster comprising:
creating a raster-based model for a region including field m to assess whether field m was too wet for planting;
entering Earth observation images and processing the image data to determine water-band shortwave infrared light reflectance;
entering an historical record of PP claims filed in the region including field m under consideration;
entering antecedent precipitation data from weather stations in the region containing each field m under consideration;
interpolating for all pixels across the region containing each field m, the antecedent precipitation data and entering the precipitation data into the model;
entering mapped soil data from public databases into said raster-based model raster for the region including each field m under consideration;
enter a shapefile for each field m under consideration into said raster-based model;
calculating a wetness index from said short wave infrared light raster for each raster pixel and enter said pixel wetness index into said model;
calculating a probability for whether a PP claim experienced PP conditions; and
sending the adjuster to any field m to examine and record of wetness if the predicted probability for PP conditions in field m are within the least 5% of the predicted probability for the collective PP claims in said region for the field under consideration.

13. The method of claim 12 wherein for any field in the region, visiting of a crop loss adjuster on any particular day and for any crop-loss reason, is based on said NWI calculated for that time of year.

14. The method of claim 1 additionally comprising the step of applying the statistically-based model throughout a calibrated region in order to forecast the likely area of PP claims and the amount of the financial set-aside necessary for claim payment by the AIP.
